(19) United States
(12) Patent Application Publication
(10) Pub. No.: US 2026/0175083 A1
(43) Pub. Date: Jun. 25, 2026

(54) FORM FEEDBACK NEGOTIATION

(71) Applicant: Tonal Systems, Inc., San Francisco, CA (US)

(72) Inventors: Steven Mark Hirsch, Toronto (CA); Giuseppe Barbalinardo, Berkeley, CA (US); John Christie, Phoenix, AZ (US)

(21) Appl. No.: 18/987,797

(22) Filed: Dec. 19, 2024

(51) Int. Cl. A63B 24/00; A63B 71/06; G06F 40/40

(52) U.S. Cl. CPC A63B 24/0062; A63B 71/0622; G06F 40/40; A63B 2024/0068; A63B 2071/0625; A63B 2071/0655; A63B 2071/0663; A63B 2225/20; A63B 2225/50

(57) ABSTRACT

A method for providing form feedback is disclosed. An indication is received that, for a repetition of an exercise movement performed by a user: a first type of incorrect form has been detected with performing of the repetition of the exercise movement; and a second type of incorrect form has been detected with performing of the repetition of the exercise movement; wherein the first type and second type of incorrect form are detected based on sensor data collected from one or more hardware sensors. Respective first and second scores for the first and second types of incorrect form that have been detected are determined. An appropriate intervention to provide to the user based at least in part on the scoring is determined.

### BACKGROUND OF THE INVENTION

Health, fitness, and technology may be used in ways that significantly enhance user well-being and extend their health-span. Exercising with a sole focus on improving traditional fitness-based outcome measures such as strength and endurance may exacerbate movement strategies that increase risk of injury. A deeper insight is that a user's movement quality is the foundation for their strength, endurance, and flexibility/mobility. It has been shown that exercising with a focus more on movement quality more positively impacts how people move, while making them just as fit as those who focus only on traditional fitness-based outcomes.

### BRIEF DESCRIPTION OF THE DRAWINGS

Various embodiments of the invention are disclosed in the following detailed description and the accompanying drawings.

FIG. 1 is a functional diagram illustrating a programmed computer/server system for form feedback negotiation for an exercise machine in accordance with some embodiments.

FIG. 2 is a block diagram illustrating an embodiment of a strength training machine.

FIGS. 3A, 3B, and 3C are illustrations of movement quality examples.

FIG. 4 is a block diagram illustrating an embodiment of a brain for form feedback negotiation.

FIG. 5 is an illustration of two screen shots for a post-set video report.

FIG. 6A is a sample code illustrating an embodiment of a process for a form feedback manager.

FIG. 6B are sample code parameters illustrating an embodiment of a process for a form feedback manager.

FIG. 6C is sample code console output illustrating an embodiment of a process for a form feedback manager.

FIG. 7 is a block diagram illustrating an embodiment of an architecture for synthesis of form feedback data.

FIG. 8 is a block diagram illustrating an embodiment of a data pipeline for synthesis of form feedback data.

FIG. 9 is a flow diagram illustrating an embodiment of a process for form feedback negotiation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Negotiating form feedback to improve movement quality for an exercise machine is disclosed. In one embodiment, the exercise machine is a strength training machine. In one embodiment, a coach/feedback brain negotiates form feedback, wherein a brain as referred to herein comprises a collection of structured representations and logical flows of information, referred to herein as a knowledge graph, to yield types of coaching cues based on how someone has moved. Inputs to the brain may include form feedback recognition parameters, user-specified feedback, context from a movement assessment, and/or an experience level of a user in terms of exercise movements. Outputs from the brain may include form feedback text prompts, audio prompts, visual overlays, and/or haptic feedback.

Put another way, for an exercise machine with multiple modes of detecting form feedback or multiple sensors detecting form feedback, prioritizing the set of form feedback to deliver one that is more relevant to the user is disclosed

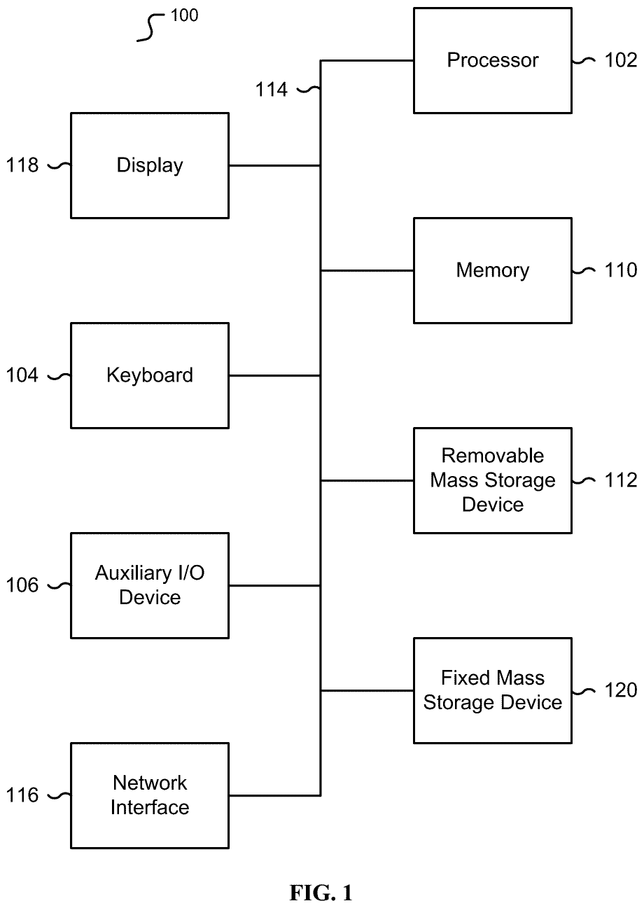

FIG. 1 is a functional diagram illustrating a programmed computer/server system for form feedback negotiation for an exercise machine in accordance with some embodiments. As shown, FIG. 1 provides a functional diagram of a general purpose computer system programmed to provide form feedback negotiation for an exercise machine in accordance with some embodiments. As will be apparent, other computer system architectures and configurations may be used for form feedback negotiation for an exercise machine.

Computer system 100, which includes various subsystems as described below, includes at least one microprocessor subsystem, also referred to as a processor or a central processing unit (“CPU”) (102). For example, processor (102) can be implemented by a single-chip processor or by multiple cores and/or processors. In some embodiments, processor (102) is a general purpose digital processor that controls the operation of the computer system 100. Using instructions retrieved from memory (110), the processor (102) controls the reception and manipulation of input data, and the output and display of data on output devices, for example display and graphics processing unit (GPU) (118).

Processor (102) is coupled bi-directionally with memory (110), which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor (102). Also as is well known in the art, primary storage typically includes basic operating instructions, program code, data, and objects used by the processor (102) to perform its functions, for example programmed instructions. For example, primary storage devices (110) can include any suitable computer-readable storage media, described below, depending on whether, for example, data access needs to be bi-directional or uni-directional. For example, processor (102) can also directly and very rapidly retrieve and store frequently needed data in a cache memory, not shown. The processor (102) may also include a coprocessor (not shown) as a supplemental processing component to aid the processor and/or memory (110).

A removable mass storage device (112) provides additional data storage capacity for the computer system (100), and is coupled either bi-directionally (read/write) or uni-directionally (read only) to processor (102). For example, storage (112) can also include computer-readable media such as flash memory, portable mass storage devices, holographic storage devices, magnetic devices, magneto-optical devices, optical devices, and other storage devices. A fixed mass storage (120) can also, for example, provide additional data storage capacity. One example of mass storage (120) is an eMMC or microSD device. In one embodiment, mass storage (120) is a solid-state drive connected by a bus (114). Mass storages (112), (120) generally store additional programming instructions, data, and the like that typically are not in active use by the processor (102). It will be appreciated that the information retained within mass storages (112), (120) can be incorporated, if needed, in standard fashion as part of primary storage (110), for example RAM, as virtual memory.

In addition to providing processor (102) access to storage subsystems, bus (114) can be used to provide access to other subsystems and devices as well. As shown, these can include a display monitor (118), a communication interface (116), a touch (or physical) keyboard (104), and one or more auxiliary input/output devices (106) including an audio interface, a sound card, microphone, audio port, audio recording device, audio card, speakers, a touch (or pointing) device, haptic device, and/or other subsystems as needed. Besides a touch screen and/or capacitive touch interface, the auxiliary device (106) can be a mouse, stylus, track ball, or tablet, and is useful for interacting with a graphical user interface.

The communication interface (116) allows processor (102) to be coupled to another computer, computer network, or telecommunications network using a network connection as shown. For example, through the communication interface (116), the processor (102) can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor (102) can be used to connect the computer system 100 to an external network and transfer data according to standard protocols. For example, various process embodiments disclosed herein can be executed on processor (102), or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, 5G, GSM, NB-IoT, LTE-M, LoRa, LoRaWAN, Sigfox, Zigbee, Z-Wave, MQTT, Ethernet, TCP/IP, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), Thunderbolt, FireWire, Serial ATA, 1-Wire, UNI/O, or any form of connecting homogenous, heterogeneous systems and/or groups of systems together. Additional mass storage devices, not shown, can also be connected to processor (102) through communication interface (116).

An auxiliary I/O device interface, not shown, can be used in conjunction with computer system 100. The auxiliary I/O device interface can include general and customized interfaces that allow the processor (102) to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus (114) is illustrative of any interconnection scheme serving to link the subsystems. Other computer architectures having different configurations of subsystems may also be utilized.

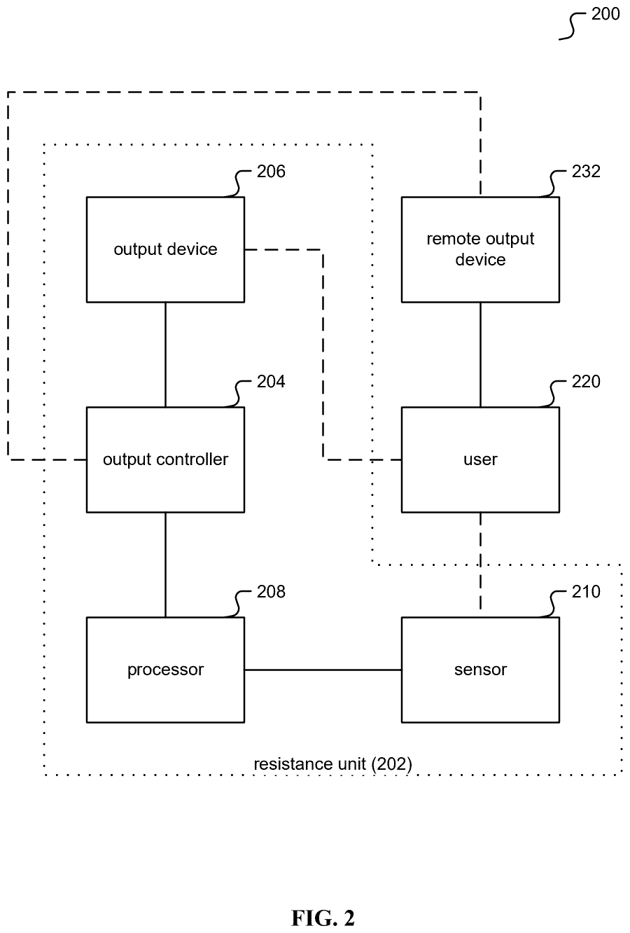

FIG. 2 is a block diagram illustrating an embodiment of a strength training machine. In one embodiment, the processor (208) of FIG. 2 is the processor (102) of FIG. 1. In one embodiment (200), within the exercise machine (202) itself that provides resistance to motion against which the user (220) exercises, the system includes: an output controller (204) which may include a memory comprising exercise machine control information, feedback information, and storage comprising video, audio, and text or icon content as well as sequencing instructions; one or more output devices (206) such as a display and/or speakers (206) needed to present feedback to the user; a central processor (208); and a sensor (210) to assess user form/performance to provide user feedback. With this system, user form/performance may be tracked throughout the exercise period and user data accumulated and stored. In one embodiment, the exercise machine (202) may comprise a user actuator such as a handle that the user exerts against, a cable coupled to the actuator, and a motor coupled to the cable, wherein the motor provides resistance when the user pulls the actuator.

Output devices (206) as referred to herein includes: a cable-based haptic device, an actuator-based haptic device, a display, a speaker, or a device for outputting one or more of the following: a text prompt, an audio prompt, a visual overlay, or a haptic feedback. As referred to herein, a remote device is a device that is not inside the resistance unit/exercise machine (202) such as a remote camera, remote sensor, or remote output device in a mobile phone, mobile tablet, smartwatch, and/or mobile device.

In one embodiment, a supplemental or replacement remote output device (232) away from the resistance unit/exercise machine (202) may be used such as a smartwatch-based haptic device, smart apparel (with embedded sensors), smart glasses/eyewear, a smartwatch-based speaker, a mobile device display, a mobile device speaker, or a remote device for outputting one or more of the following: a text prompt, an audio prompt, a visual overlay, a virtual reality, an augmented reality, or a haptic feedback.

Sensor (210) as referred to herein includes: an electromyography sensor, a camera, a cable-based sensor, an actuator-based sensor, an inertial unit such as an inertial measurement unit (IMU) in an actuator, a motor sensor, a back EMF sensor, an IMU remote to the exercise machine such as a glove or smartwatch, a power switch, a clock, a calendar, a touch screen, a button or touch-based control interface, a remote button or touch-based controller, a microphone, a depth sensing camera, a seat sensor, a push force sensor for a user foot, a pull force sensor for a user foot, a database query result, a seat to rail position sensor, an actuator position sensor, an actuator orientation sensor, an actuator button, an actuator speed sensor, an actuator acceleration sensor, a cable position sensor, a cable speed sensor, a cable acceleration sensor, a cable tension sensor, a torque sensor, a current sensor, a voltage sensor, a power sensor, and/or a wearable sensor such as a watch or belt to pick up on biometrics such as a heart rate sensor, pulse-ox, respiration, position, and so on. In one embodiment, the sensor (210) may also include (not shown in FIG. 2) a supplemental or replacement remote sensor away from the resistance unit/exercise machine (202) such as a mobile device camera, smart apparel, a smartwatch inertial sensor, and/or a smartwatch camera.

This data may be analyzed and compared with other available information which allows user exercise to be compared and movement quality assessed. Workouts comprising sets of repetitions (or “reps”) may be planned and then analyzed dynamically/on the fly as a user proceeds and/or analyzed after a complete rep and/or set. A user's progress may provide user context and feedback may be dynamically altered to modify a simulated coaching to best encourage or improve a user's movement quality.

Context as referred to herein includes: personalized identifier, user name, user age, user sex, user height, user weight, user health history, user workout history, user heart rate, user respiration rate, user VO2 max, joint range of motion, user segment lengths, previous injury history, anatomical limitations, user oxygen saturation, user body temperature, user activity tracking, user fitness tracking, user sleep tracking, user mood, user coaching style preference, user preferences, environmental temperature, environmental humidity, location, altitude, workout, movement, set number, rep number, user performance for current and historical/past reps, user plan for future reps, historical/past and current coaching content, exercise machine physical configuration, exercise machine status, and/or whether the exercise machine is in an emergency stop.

In one embodiment, the exercise appliance (202) passes a load/resistance against the user via one or more lines/cables, to an actuator such as a grip/handle that a user displaces to exercise. The actuator may be positioned relative to the user using a load arm and the load path to the user may be steered using pulleys at the load arm ends. The load arm may be connected to the exercise appliance frame using a carriage that moves within a track that may be affixed to the main part of the frame. In one embodiment, the frame is firmly attached to a rigid structure such as a wall.

In one embodiment, the appliance (202) includes a controller (204) and/or processor (208) which monitors/measures user performance/form, for example, using one or more sensors (210), and determines loads to be applied to the user's efforts in the resistance unit (202). Without limitation, the controller (204) and processor (208) may be separate control units or combined in a single package. The controller (204) is further coupled to an output channel (206) such as a display/audio channel (206) that allows feedback information to be presented to a user (220) and with which the user (220) interacts in a visual manner, referred to herein as any method of communication based on the eye such as video and/or text or icons, an auditory manner, referred to herein as any method of communication based on the ear and/or mouth such as verbal speech, text-to-speech synthesis, and/or music, and/or a haptic manner, referred to herein as any method of communication based on touch such as tactile force, vibrations, motions, rotations, translations, rumble, force feedback, air vortex, ultrasound, electrical stimulation, and/or skin tap. A display (206) may be incorporated into the exercise machine. In one embodiment, the display (206) is a large format, surround screen representing a virtual reality/alternate reality environment to the user; a virtual reality and/or alternate reality presentation may also be made using a headset (206).

In one embodiment, the appliance controller (204) provides audio information that is related to the visual information from a program store/repository that may be coupled to external devices or transducers (206) to provide the user with an auditory experience that matches the visual experience. Control instructions that set the operational parameters of the resistance unit (202) for controlling the load or resistance for the user may be embedded with the user information so that the media/feedback package includes everything needed for the controller to run the machine. In this way a user (220) may choose an exercise regime and may be provided with cues, visual and auditory feedback as appropriate, that allow the actions of a personal trainer to be emulated. The output controller (204) may further emulate the actions of a trainer using an expert system and thus exhibit artificial intelligence (AI). The user may better form a relationship with the emulated coach or trainer, and this relationship may be encouraged by using emotional/mood cues whose effect may be quantified based on performance metrics gleaned from exercise records that track user performance in a feedback loop using, for example, the sensor(s) (210).

The appliance processor (208) may also be coupled to the environmental control for the exercise area so that exercise parameters may be optimized, adjusting lighting, temperature, and humidity as appropriate based on telemetry such as home automation telemetry via an API, and/or sensors (210). The controller (204) and/or processor (208) may also be responsive to the environmental conditions prevailing so that the exercise routines may be moderated to stay within reasonable performance expectations; for example, if the humidity is high, a lower rate of working may be requested from the appliance either under automatic control by the controller logic, or at the user's request. The appliance (202) may be entirely self-contained and/or connected to a data service that allows the appliance's exercise program or programs and operational parameters to be changed.

The appliance controller (204) determines and schedules not only the operation of the exercise appliance, but also the actions of one or more coaches who appear to the user (220). The coach may be a virtual coach, an abstraction such as an animation or other drawn art coach, and/or a live coach. The load or resistance applied, against which a user exercises, is determined by the processor (208) and may be provided by one or more action devices, such as an electric motor which facilitates a wide range of exercise parameters. Sensor(s) (210) measure user action and this information may be processed by the controller (204) and processor (208) to be used interactively with exercise parameters.

As an improvement over traditional techniques with static visual/auditory run on an exercise machine, beyond movement quality such an appliance (202) may personalize coaching for a user (220) and/or otherwise improve encouragement for the user (220) to continue with an exercise regime provided by the exercise machine, which is physically beneficial to the user and/or may be otherwise less boring. Because the controller is able to determine the user status at any time during exercise, exercise conditions may be adapted dynamically and the actions of the trainer/coach may be adjusted in near-real time to reflect changes, which improves user encouragement and/or trust in the exercise machine.

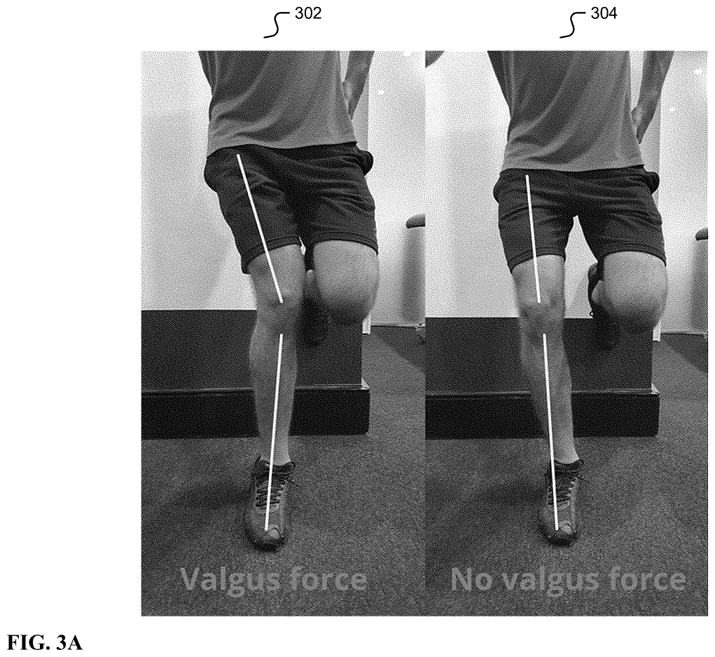

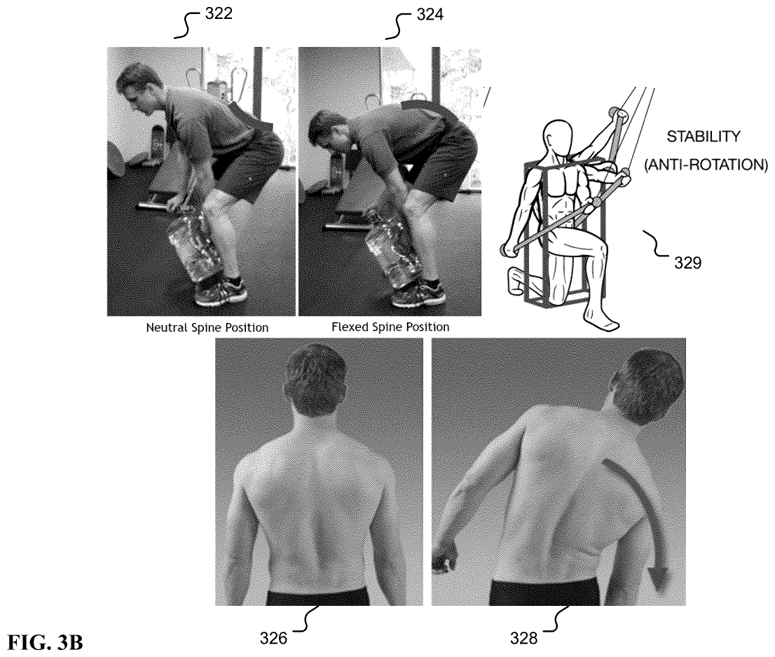

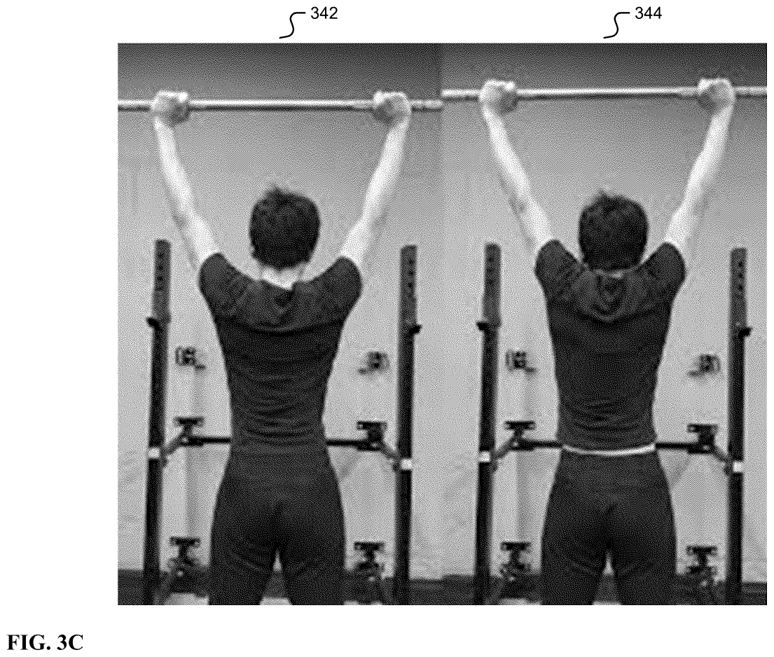

FIGS. 3A, 3B, and 3C are illustrations of movement quality examples. FIG. 3A is an illustration of movement quality for knee motion. Illustration (302) shows an example of poor knee motion while illustration (304) shows an example of better knee motion and/or better movement quality. As shown in FIG. 3A, a movement quality goal is to avoid valgus motion of the knee as it may increase loading on passive anatomical structures, for example ligaments, meniscus, and/or tendons, with limited adaptive capacity relative to active anatomical structures such as muscles. Put another way, valgus motion of the knee (302) is when a user's knees are collapsing inwards. Valgus motion of the knee (302) has been biomechanically and epidemiologically linked to increased injury risk.

FIG. 3B is an illustration of movement quality for spine motion. Illustration (324) shows an example with poor spine motion with a flexed spine position, while illustration (322) shows an example with better spine motion with a neutral spine position and/or better movement quality. Illustration (328) shows an example with poor spine motion with a rotated spine position, while illustration (326) shows an example with better spine motion with a neutral spine position. Illustration (329) depicts a figurative example of how a better spine motion promotes stability with the box while a user moves their arms.

As shown in FIG. 3B, a movement quality goal is to avoid excessive motion about the lumbar spine while allowing other joints surrounding the spine such as shoulders and hips, to generate energy when moving. Excessive spine motion such as flexing (324) or rotation (328) has been biomechanically and epidemiologically linked to increased injury risk.

FIG. 3C is an illustration of movement quality for shoulder motion. Illustration (344) shows an example with poor shoulder motion with shrugging shoulders, while illustration (342) shows an example with better shoulder motion with less shrugging and/or better movement quality. A movement quality goal is to avoid excessive shrugging in the shoulders towards ears during pushing and pulling exercises, and to avoid moving shoulders excessively. Excessive moving/shrugging (342) in shoulders has been biomechanically and epidemiologically linked to increased injury risk.

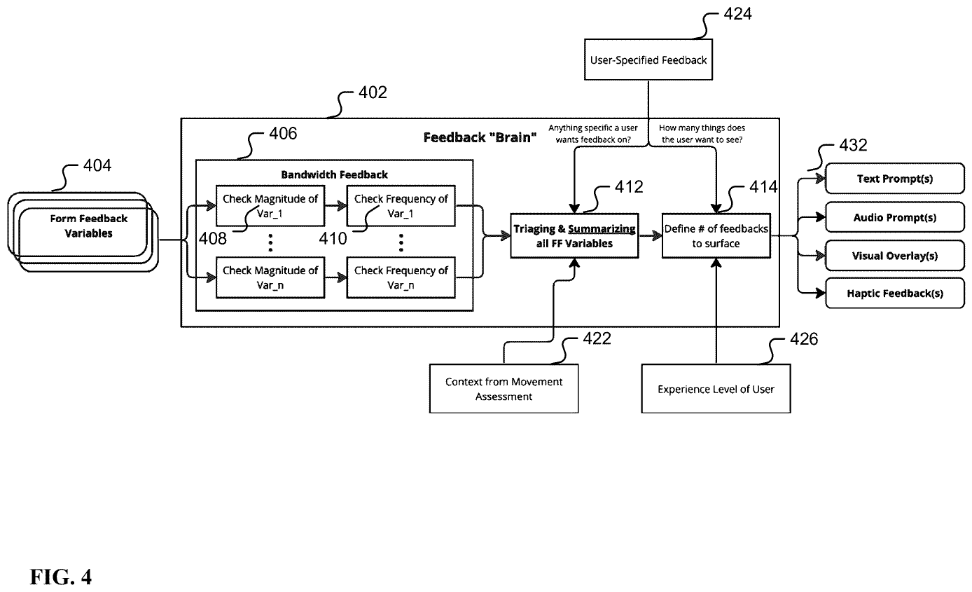

FIG. 4 is a block diagram illustrating an embodiment of a brain for form feedback negotiation. In one embodiment, the system of FIG. 4 is rendered by processor (208) and/or controller (204) in FIG. 2.

In one embodiment, the coach brain of FIG. 4 includes structured representations and logical flows of information, that is a knowledge graph, to yield various types of coaching cues based on how someone has moved. These knowledge graphs can be built on top of simple logical flows or decision trees to surface pre-determined feedback to a user. Other branches of this coach brain may be augmented with Large Language Models (LLMs) that are trained specifically to provide constrained text feedback to the user that minimizes the likelihood of hallucinations and maximizes accuracy. The outputs of these knowledge graphs may also be fine-tuned over time with contextual knowledge learned from an aggregated database to provide more relevant feedback to a user based on historical data, both of that person and from populations of users.

In one embodiment, knowledge graphs are structured representations of information where entities such as people, places, or concepts are interconnected through relationships, forming a network of linked data. This graph format allows for efficient organization and retrieval of complex, contextual information, such as the application of motor learning principles in exercise settings. Integrating knowledge graphs with LLMs allow the model to gain access to a well-organized, evidence-based repository of relationships, enhancing its ability to generate accurate, context-aware responses. This structured data from the knowledge graph helps narrow the scope of relevant information, improving the accuracy of its outputs while minimizing the likelihood of the model hallucinating incorrect responses. Knowledge graphs may operate similarly to traditional retrieval augmented generation (RAG) LLMs whereby instead of looking at a database of natural language text files to refine the LLM output, a series of complex relationships is instead used to constrain the LLM. Both the knowledge graph, as well as the LLM used to deliver the natural language, may be trained and refined over time to provide unique outputs.

Simple Brain Example for Clarity. For illustrative purposes and without limitation, a linear weighted brain embodiment is described below. The feedback/coach brain (402) takes as a primary input form feedback variables (404) from the exercise machine/strength trainer such as (202) in FIG. 2, based at least in part on the resistance unit's hardware sensor (210). An example of a form feedback variable (404) is one assessing valgus motion in the knees, such as that shown in (302) in FIG. 3A. The brain (402) comprises a bandwidth feedback subsystem (406) that checks the magnitude of a form feedback variable for the performed current movement in a rep (408), and frequency of the form feedback variable (410). In parallel a plurality of form feedback variables and movements are assessed near simultaneously, so that knee valgus force may be assessed at the same time shoulder shrugging is assessed.

The bandwidth feedback (406) may weight and/or linearly weight these different movements to advance form feedback negotiation. This form feedback variables may then be triaged and/or summarized (412) in order to assess how the user is moving, and at this stage external context from movement assessment (422) may be incorporated, such as context that the user is recovering from a knee injury. User-specified feedback (424) such as a priority to focus on knee valgus motion that the user wants feedback on is also integrated at this stage.

At the next stage the number of feedbacks that may be surfaced (414) is determined, optionally based in part on the experience level of user (426) which may be assessed by the user themselves or the exercise machine/trainer (202). Based on the brain (402) logic, a metadata (432) may be provided to render an output user experience using the output controller (204) of FIG. 2. Examples of this metadata (432) include one or more combination of text prompts, visual overlays, audio prompts, and/or haptic experiences.

A brain (402) is adaptive to a specific user, for example with their specific demographics, physiology, and experience level. Context from a user informs brain (402) on how to provide feedback. For example, if a user has limited range of motion, the one or more sensors (210) may observe they are not moving with a dynamic range of motion. The brain will avoid constantly cueing such a user “Use more range of motion” that they do not have in order to needlessly frustrate a user with their own limitation that is outside their control. Similarly, users with a beginner level of experience may be overwhelmed by too many differing form feedback so a priority/negotiation of the more significant form feedback is helpful for a beginner. This experience level may be self-assessed by the user, and this self-assessment may be modified and/or replaced by exercise machine (202) observation, for example through sensors (210).

Thus, a brain (402) may assess that a specific user as a beginner and that they may do better with fewer prompts, but as the user becomes more experienced they may handle more prompts and more feedback relatively, and the brain (402) may then assess it appropriate to render two or more different feedback prompts (432) relative to a beginner where they get one. The brain (402) may establish a feedback loop where the user specifies more of the constraints surrounding the feedback that gets provided to them. For example, if the user asserts they want more feedback on a particular feature of their movement, the weighting in the bandwidth feedback logic (406) is adjusted appropriately. The intelligence engine (402) thus takes in a variety of factors, contextualizes them, and better summarizes what to surface, when to surface it, and how to surface that information to a user.

In one embodiment, the feedback negotiation described in FIG. 4 is run in real-time during a set, where movement is happening and fresh, improving motor learning by being close to the time of movement quality issues. In real-time, a user, especially with beginner expertise, may only absorb a single or fewer user feedback. Real-time feedback may occur at the end of every rep, and in urgent cases may occur in the middle of a rep.

In one embodiment, the feedback negotiation described in FIG. 4 is run post-workout, when a user has more time to review feedback and have less cognitive overload. In post-workout, a user also has time to appreciate a more absorbing experience such as a review video with visual landmarks to show on the video, to provide video feedback to the user.

Weighting Function of the Brain. In the bandwidth feedback module (406), a weighting function may be used through heuristics and/or dynamically through machine learning and/or an LLM. Another input (not shown in FIG. 4) to the feedback module (406) permits it to use not only the current feedback in the current movement and exercise but adds a memory in terms of how well the user has performed in the past for the same or similar movements.

In one embodiment, the weighting function assigns a practical severity and a frequency of a specific movement fault and combines and/or scores them linearly. For example, for a racked squat movement and knee movement fault, if a user's knees are not in line with hips and feet, this may score a severity of 0.3, and if a user's lumbar spine flexes excessively, this may score a severity of 0.7. Weighting functions may also be applied nonlinearly such that each successive movement fault has an increasing severity score associated with it. For example, on the first rep where the user's knees are not in line with the hips and feet the severity score may be 0.3, but could double on each subsequent repetition (e.g., severity score of 0.6 on repetition two, 1.2 on repetition three, and so on.)

In one embodiment, in real-time each rep of a set is observed and a score is accumulated for form feedback, rep by rep. As the reps and score accumulates, the bandwidth feedback module (406) in real-time may use a “first pass the post” type system where the first type of movement fault that exceeds a threshold for large magnitude and/or high enough frequency triggers the main priority to highlight for a user. The feedback metadata (432) is then asserted in real-time for output to the user. Without limitation, for more experienced users a greater number of feedback prompts may be output, for example the first two types of movement faults to “pass the post.”

In one embodiment, post-set the bandwidth feedback module (406) does not use the “first pass the post” system and can wait until the end of the set to assess the ranking of all form feedbacks in terms of frequency and magnitude scaled by severity. The feedback metadata (432) may then methodically go through in priority order the ranked movement faults.

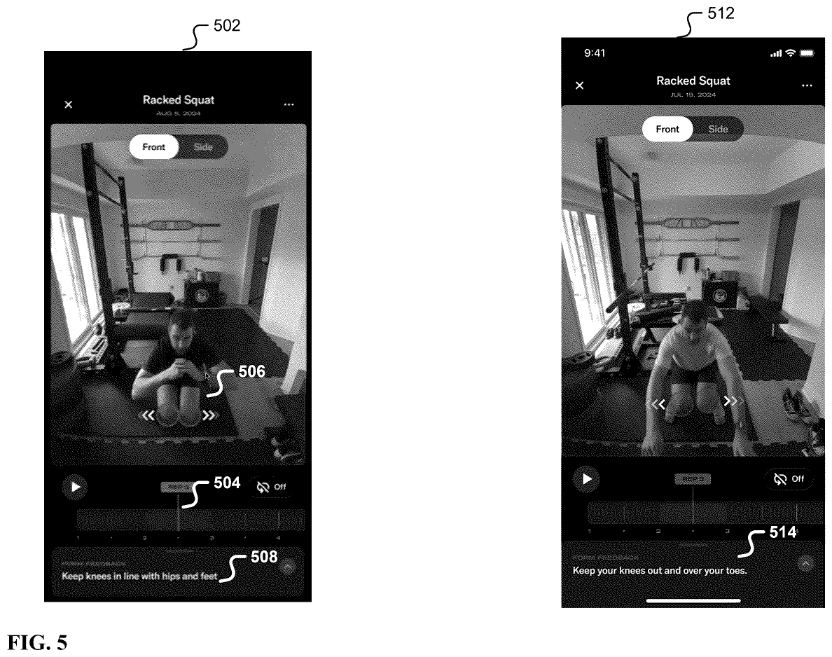

FIG. 5 is an illustration of two screen shots for a post-set video report. In one embodiment, the screen shots are from a mobile device (232) that a user uses to review, wherein the output shown in FIG. 5 is rendered from the output controller (204) from metadata (432) provided by the brain (402). In one embodiment, the screen shots are on a display (206) on the resistance unit (202), wherein the output shown in FIG. 5 is rendered from the output controller (204) from metadata (432) provided by the brain (402).

In a first screen shot (502) of a racked squat on Aug. 8, 2024, a user is shown a video of their set and reps, wherein a timeline (504) shows their progress in rep 3. There is a visual overlay rendering of both circles around the user's knees (506) with arrows indicating direction for improved movement quality. There is a text prompt rendered (508) to “Keep knees in line with hips and feet.” In a second screen shot (512) a historical video from Jul. 19, 2024 is shown for the same racked squat movement to compare, showing a timeline for rep 2 back then, with a visual overlay rendering of both circles around the user's knees with arrows indicating direction for improved movement quality and a text prompt rendered (514) to “Keep your knees out and over your toes.”

Haptic Feedback. In one embodiment, not shown in FIG. 5, haptic feedback is rendered from the output metadata (432) of FIG. 4. An improvement of adding haptic feedback is that it can be absorbed without much cognitive load for a user. In one embodiment, tactile buzzes are rendered for a user, for example if a user is flexing their spines too much, a tactile buzz is sent to the user. A user is earlier given context for urgent feedback so that when they receive a haptic feedback they interpret it as “I am moving incorrectly.” In one embodiment, haptic feedback is delivered via an output device (206) like an actuator, for example a user handle of the exercise machine (202) in FIG. 2. In one embodiment, haptic feedback is delivered via a remote output device (232), such as a mobile phone, mobile tablet, mobile device, and/or smartwatch.

Simple Audio Cues/Beeps. In one embodiment, a simple audio cue is rendered from the output metadata (432) of FIG. 4. An improvement of adding simple audio cues is that it can be absorbed without much cognitive load for a user, and is compatible with user provided audio such as podcasts, music, and/or television/movies. In one embodiment, a bell or beep is rendered for a user, for example if a user is flexing their spines too much, a bell/beep is sent to the user. A user is earlier given context for urgent feedback so that when they receive a bell/beep they interpret it as “I am moving incorrectly.” In one embodiment, simple audio cues are delivered via an output device (206) like a speaker on the exercise machine (202) in FIG. 2. In one embodiment, simple audio cues are delivered via a remote output device (232), such as a mobile phone, mobile tablet, mobile device, and/or smartwatch.

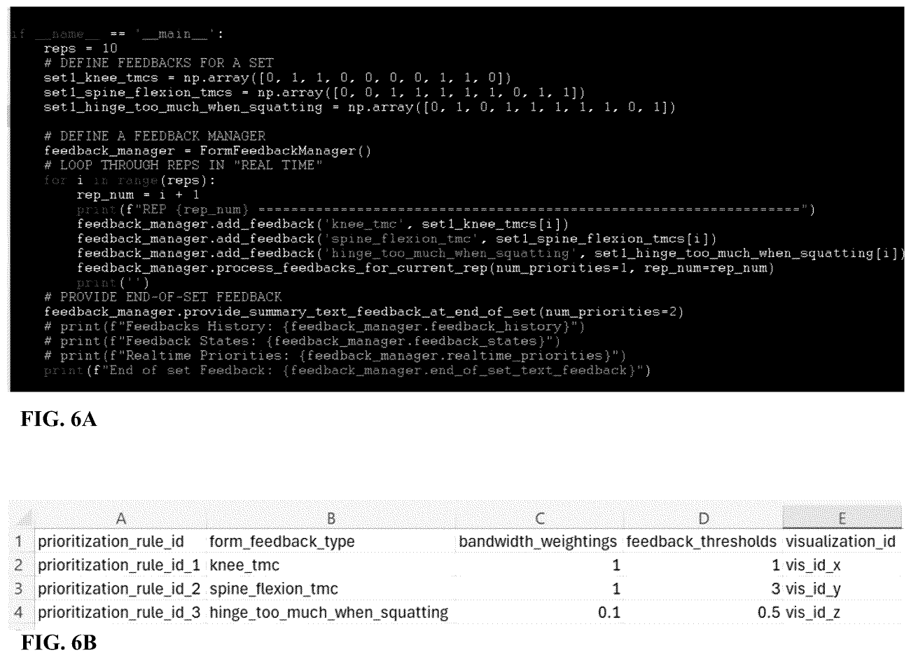

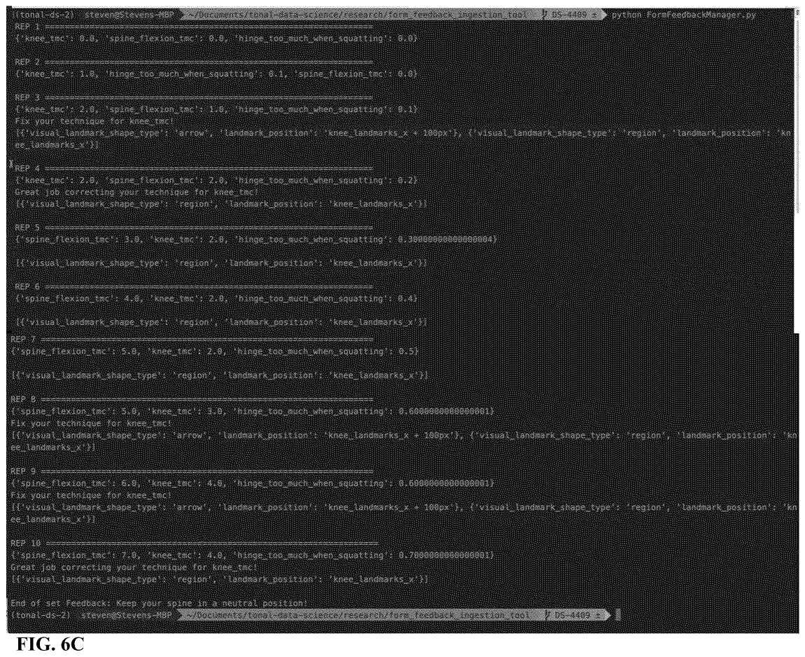

FIG. 6A is a sample code illustrating an embodiment of a process for a form feedback manager. In one embodiment, the sample code is associated with the brain (402) of FIG. 4, and gives a deterministic demonstration of a sample set and rep for a user by pre-populating form feedback variables (404) as shown in FIG. 4.

As shown in FIG. 6A, the number of reps is set to 10 in the example of FIG. 6A, and for each of those reps a series of form feedback variables (404) is set, as shown in the example of FIG. 6A:
Poor knee movement quality (set1_knee_tmcs) in reps 2, 3, 8, and 9;
Poor spine flexion movement quality (set1_spine_flexion_tmcs) in reps 3, 4, 5, 6, 7, 9, and 10; and
Poor movement quality by hinging too much when squatting (set1_hinge_too_much_when_squatting) in reps 2, 4, 5, 6, 7, 8, and 10.
   These form feedback variables (404) may also be thought of as form feedback triggers (404), triggered by one or more sensors (210) of FIG. 2 and/or remote sensors to detect, for example, a hinge too much when squatting. In one embodiment, a resistance unit camera from a front angle is used in part to trigger poor movement quality. In one embodiment, a remote camera from a side angle is used in conjunction with a resistance unit camera from a front angle in part to trigger poor movement quality. In one embodiment, sensor fusion is used to detect and/or trigger poor movement quality with example sensors being fused including one or more of the following: a camera, a cable-based sensor, an actuator-based sensor, and/or a motor-based sensor.

As shown in FIG. 6A, a feedback manager is defined with class FormFeedbackManager( ) to showcase how the brain (402) processes the series of form feedback variables/triggers (404), outputting to a console the rep number then adding the rep's form feedback variable and processing the feedback for a current rep in real-time using FormFeedbackManager.process_feedbacks_for_current_rep. In the example shown in FIG. 6A, the processing of feedback accepts as parameter a number of priorities to render as part of triage (412) and definition (414) as shown in FIG. 4, in this case one feedback as num_priorities=1.

As shown in FIG. 6A, the feedback manager also provides end of set feedback as a summary (412) using FormFeedbackManager.provide_summary_text_feedback_at_end_of_set which also accepts as parameter a number of priorities to render, in this case two feedbacks as num_priorities=2.

FIG. 6B are sample code parameters illustrating an embodiment of a process for a form feedback manager. In one embodiment, the sample code parameters are associated with the brain (402) of FIG. 4, in particular heuristic parameters for the bandwidth feedback module (406) as shown in FIG. 4. In one embodiment, machine learning parameters such as that derived from an LLM may be used instead of the illustrative code parameters used in FIG. 6B.

As shown in FIG. 6B, the sample code parameters detail, for a form feedback type, a bandwidth weighting and a feedback threshold, amongst other aspects. Not shown in FIG. 6B without limitation is a frequency threshold for a given feedback type, which indicates a frequency of movement quality faults that require attention, such as flagging a poor knee movement quality trigger that happens for 5 or more reps, regardless of the magnitude. Not shown in FIG. 6B without limitation is a consecutive factor for a given feedback type, which indicates an increased weighting for movement quality faults that happen consecutively, such as flagging a poor knee movement quality trigger than happens three times in a row, regardless of magnitude and/or frequency. For example, in FIG. 6B:
For a poor knee movement quality trigger (knee_tmc) a bandwidth weighting of 1 is set with a feedback threshold of 1;
For a poor spine flexion movement quality trigger (spine_fiexion_tmc) a bandwidth weighting of 1 is set with a feedback threshold of 3. With the higher feedback threshold of spine over knee, the heuristics/machine learning set up shows that correcting poor knee movement quality is more important than correcting poor spine flexion movement; and
For a poor movement quality trigger when there is a hinge too much when squatting (hinge_too_much_when_squatting) a bandwidth weighting of 0.1 is set with a feedback threshold of 0.5. Different categories of form feedbacks have different weightings to allow for post exercise set determination of what may be the most important insight to surface for an individual.

FIG. 6C is sample code console output illustrating an embodiment of a process for a form feedback manager. In one embodiment, the sample code console output is associated with the brain (402) of FIG. 4, in particular the output metadata (432) as shown in FIG. 4 for the a deterministic demonstration of a sample set of triggers shown in FIG. 6A and bandwidth feedback weighting of FIG. 6B.

As shown in FIG. 6C, the brain (402) uses form feedback negotiation to resolve conflicting kinds of form feedback:
In rep 1, no triggers (404) occur and subsequently no feedback (432) is output;
In rep 2, a knee trigger and hinge trigger (404) occur, but no feedback (432) is output as no thresholds from FIG. 6B have been exceeded. That is, a knee trigger magnitude is 1, so the first knee trigger accumulates a knee feedback of 1×1=1, which is less than the knee feedback threshold of 1. Without limitation, the example shown uses a linear accumulation but other non-linear comparison and/or accumulation is also used. Similarly a hinge trigger magnitude is 0.1 so the first hinge trigger accumulates a hinge feedback of 0.1×1=0.1, which is less than the hinge feedback threshold of 0.5;
In rep 3, a knee trigger and a spine trigger (404) occur, and feedback (432) is output. That is, each of the feedback is updated with the rep's triggers so the knee feedback accumulates another 1×1=1, which is added to rep 2's feedback to result in a knee feedback of 2, which exceeds the knee threshold of 1. Similarly a spine feedback trigger accumulates a spine feedback of 1×1=1, which is less than the spine feedback threshold of 3. As the knee feedback is the first feedback type to be “first past the post”, an output metadata (432) is sent for rendering with content “Fix your technique for knee_tmc!” and associated visual landmarks for arrows and regions, to further enable a visual overlay such as that shown (506) in FIG. 5. These visual landmarks may be associated for each form feedback type, as shown as visualization_id in FIG. 6B;
In rep 4, a spine and hinge trigger (404) occur, and feedback (432) is output. Similar to the previous reps, spine feedback is accumulated to 2 and hinge feedback is accumulated to 0.2. The brain (402) observes the absence of a knee trigger occurring, as the knee feedback does not accumulate and stabilizes at 2, thus an output metadata (432) is sent for rendering with content “Great job correcting your technique for knee_tmc!”
In rep 5, a hinge trigger (404) occurs, and hinge feedback is accumulated to 0.3;
In rep 6, a spine trigger and hinge trigger (404) occur, and spine feedback is accumulated to 4 and hinge feedback is accumulated to 0.4. While this spine feedback is now greater than the spine feedback threshold of 3, because the knee feedback was the first feedback type to be “first past the post” in rep 3, no output metadata (432) is sent regarding the spine movement quality. The improvement of this is that it focuses the user's cognitive function on the more important knee movement quality;
In rep 7, a spine and hinge trigger (404) occur, and spine feedback is accumulated to 5 and hinge feedback is accumulated to 0.5. Again, while this spine feedback is now greater than the spine feedback threshold of 3, because the knee feedback was the first feedback type to be “first past the post” in rep 3, no output metadata (432) is sent regarding the spine movement quality;
In rep 8, a knee and hinge trigger (404) occur, and knee feedback is accumulated to 3 and hinge feedback is accumulated to 0.6. While this hinge feedback is now greater than the hinge feedback threshold of 0.5, because the knee feedback was the first feedback type to be “first past the post” in rep 3, no output metadata (432) is sent regarding the hinge movement quality. The brain (402) observes that a knee trigger has happened again while the knee feedback exceeds the threshold. As the knee feedback is the first feedback type to be “first past the post”, an output metadata (432) is sent for rendering with content “Fix your technique for knee_tmc!” and again associated visual landmarks for arrows and regions, to further enable a visual overlay such as that shown (506) in FIG. 5;
In rep 9, a knee and spine trigger (404) occur, and knee feedback is accumulated to 4 and spine feedback is accumulated to 6. Again, while this spine feedback is now greater than the spine feedback threshold of 3, because the knee feedback was the first feedback type to be “first past the post” in rep 3, no output metadata (432) is sent regarding the spine movement quality. The brain (402) observes that a knee trigger has happened again while the knee feedback exceeds the threshold. As the knee feedback is the first feedback type to be “first past the post”, an output metadata (432) is sent for rendering with content “Fix your technique for knee_tmc!” and again associated visual landmarks for arrows and regions, to further enable a visual overlay such as that shown (506) in FIG. 5; and
In rep 10, a spine and hinge trigger (404) occur, and spine feedback is accumulated to 7 and hinge feedback is accumulated to 0.7. Again, while both spine and hinge feedback is now greater than their respective feedback thresholds, because the knee feedback was the first feedback type to be “first past the post” in rep 3, no output metadata (432) is sent regarding the spine or hinge movement quality. The brain (402) observes the absence of a knee trigger occurring, as the knee feedback does not accumulate and stabilizes at 4, thus an output metadata (432) is sent for rendering with content “Great job correcting your technique for knee_tmc!” The real-time form feedback negotiation thus ends with the last rep in the set.
   Now at the end of the set of 10 reps, the brain (402) in post-set mode describes more than just the “first past the post” but also includes a second feedback type. As the spine feedback was the “second past the post” in rep 6, it is of second priority and an output metadata (432) is sent for rendering with context “Keep your spine in a neutral position!” Visual landmarks may be used with the spine feedback, for example during a review movie of the set. In one embodiment, the first priority is also repeated, such that a “Fix your technique for knee_tmc!” is repeated with associated visual landmarks. In one embodiment, the first and second priority is integrated intelligently into an amalgamation of both primary and secondary priority feedback into a single sentence.

In one embodiment, in an example not shown in FIGS. 6A, 6B, and 6C, the brain (402) retains memory across sets to record magnitude, frequency, and/or consecutive patterns for movement type faults to indicate long-term movement quality issues, such as a user who frequently has spine flexion movement quality issues over weeks or months.

In one embodiment, for a typical strength training movement such as arm curl or bench press, there are between zero and six form feedback fault types to help guide a user improve movement quality for the given strength training movement.

In one embodiment, regulatory focus theory is used to interpret a user-specified feedback (424) in FIG. 4 in the rendering of output metadata (432) using the output controller (204) in FIG. 2. Besides user-specified feedback (424) being a user who wishes to prioritize spine over knee feedback, for example, user-specified feedback may indicate a preference for promotion versus prevention type phrasing for feedback. An example of promotion versus prevention is a promotion phrasing “Keep your knees out in line with your feet” versus a prevention phrasing “Don't collapse your knees inwards”. This may be explicitly specified by a user and/or implicitly specified/adjusted by observing performance for the user on response to past promotion or prevention phrasing using heuristics and/or machine learning such as an LLM. Another aspect of regulatory focus includes a preference for short-form and long-form text prompts depending on the cognitive processing of a user's physiology. In one embodiment, short-form text prompts are used for real-time feedback and long-form text prompts are used for post-set feedback by default, but alternate schemes may be used depending on being explicitly specified from the user and/or implicitly specified/adjusted by observing performance for the user on response to longer-form text using heuristics and/or machine learning such as an LLM.

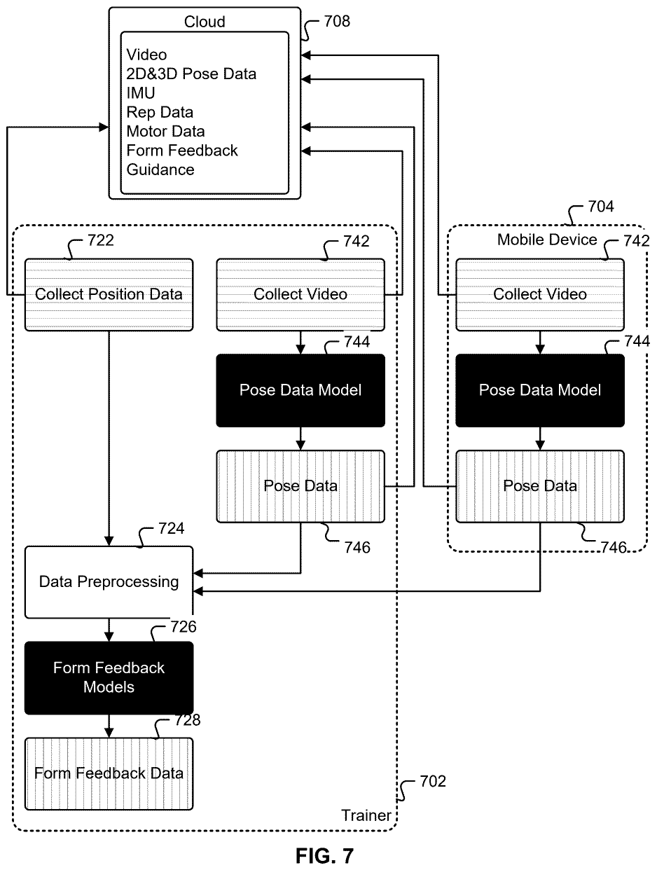

FIG. 7 is a block diagram illustrating an embodiment of an architecture for synthesis of form feedback data. In one embodiment, the system of FIG. 7 is that of FIG. 2, wherein resistance unit (202), mobile device (232), and cloud services (not shown) of FIG. 2 are shown as trainer (702), mobile device (704), and cloud services (708), respectively, in FIG. 7. In one embodiment, the form feedback data of FIG. 7 comprise the form feedback variables (404) of FIG. 4. In FIG. 7, architectural elements that comprise sensors and/or cameras are shown with a horizontal hatching pattern, models such as machine learning models are shown with white text on black background, and output from models are shown with a vertical hatching pattern.

As shown in FIG. 7, cloud services (708) includes cloud storage of data including video data/parameters, 2D and 3D pose data/parameters, IMU data/parameters, repetition/workout data/parameters, motor data/parameters, and/or form feedback expressions/data.

In one embodiment, mobile device (704) includes several services such as the collecting of video (742), for example using a built-in camera and/or remote camera. This video may be processed further in mobile device (704), trainer (702), and/or transmitted to cloud services (708). The collected video may be ingested by a pose data model (744), to convert the video to pose data. In one embodiment, synchronization, smoothing, rep detection, and/or interpolation is used when the pose data model (744) lags, for example 30 frames per second video data lags to 18 frames per second pose data. In one embodiment, a timer mechanism is used to discard pose data and/or resultant guidance if it is not triggered within an expiry time window, as there is little good guidance to give if too much time has passed after an incident has occurred. In one embodiment, pose data is made more efficient by a focus on relevant key points for the current movement. The resultant pose data (746) is sent to cloud services (708) and/or trainer (702) for multi-modal guidance.

In one embodiment, trainer (702) includes several services such as the collecting of position data such as motor and/or cable data (722). Also shown in FIG. 7 is an optional camera that may also collect video (742), convert video to pose data via a model (744), resulting with pose data (746) also sent to cloud services (708) and/or data preprocessing (724). This position data may be processed further and/or transmitted to cloud services (708). The collected position data is preprocessed (724) with the pose data (746) from mobile device (704), for example using the disclosed sensor fusion. Data preprocessing (724) includes determining joint locations using trigonometry and/or other mathematics based at least in part on machine learning to determine either which points are key points and/or how to determine key points based on trigonometric angles. That is, machine learning and/or models are used to determine what angles may be relevant as well as what the threshold values of those angles are in order to divide good form from poor form.

The preprocessed/combined data (724) may be ingested by a guidance/form feedback model (726), to classify the pose with respects to guidance/form feedback. In one embodiment, the model (726) is expressed as a machine learning framework such as a TensorFlow Lite model. In one embodiment, classification is made more efficient by a focus on relevant pose data for the current movement. In one embodiment, cloud services (708) is used as a processor and/or co-processor for models, in order to enable higher accuracy scoring. The resultant guidance/form feedback (728) is sent to the user and/or cloud services (708), in the form of at least one of the following: a score, a classification, a Boolean (good/poor), or a number, for example an assessment where a user is getting 65 out of 100. Thus, database preprocessing (724) may be thought of as creating trigger variables, for the guidance/form feedback models (726) to consume in order to provide guidance/form feedback (728).

Examples of Algebraic/Multi-Modal Combinations of Trigger Variables for Form Feedback. Two Examples of Algebraic Combinations of Trigger Variables Derived from Different Sensors, for Form Feedback, Include:
1. Inline Chest Press Hip Torso Flexion, a form feedback which combines camera data and cable data. Its algebraic construction is:

$$InlineChestPressHipTorsoFlexionProbability > 0.565 \&\&$$

$$RepCountSinceSetResumed > 1$$

wherein:
   a. InlineChestPressHipTorsoFlexionProbability is a camera based trigger variable calculated as follows: sigmoid ((−0.10053845*support_shoulder_hip_floor_angle_2d_mean)+(−0.01866572*support_shoulder_knee_hip_angle_2d_mean)+8.48501459))
   b. RepCountSinceSetResumed is a cable based trigger variable which uses the current position of the cable versus its history to count how many reps a user has performed.
2. Bench Press Wrist Rotation, a form feedback which combines IMU data and cable data. Its algebraic construction is:

$$( ( MaxRepAngularDisplacementXZ 1 >= 0 \&\&$$

$$MaxRepAngularDisplacementXZ 1 <= 20 ) ‖$$

$$( MaxRepAngularDisplacementXZ 2 >= 0 \&\&$$

$$MaxRepAngularDisplacementXZ 2 <= 20 ) \&\& RepCountSinceSetResumed >= 2$$

wherein:
   a. the MaxRepAngularDisplacementXZ1 MaxRepAngularDisplacementXZ2 variables are IMU data
   b. RepCountSinceSetResumed is a cable based trigger variable which uses the current position of the cable versus its history to count how many reps a user has performed.

Guidance without explaining why. Note that expressing form feedback and/or other guidance based at least in part on classification enables the exercise system of FIG. 7 to guide the user even if a professional athlete/performance expert/coach does not explicitly teach the exercise system how to perform an exercise movement and/or what makes up good/poor form and/or movement quality. That is, by classifying several observed “knees over toes” videos/pose data as “poor movement quality”, the professional athlete/performance expert/coach does not have to explain that knees should not be over toes in a movement, but the exercise system will indicate to the user through guidance/form feedback that it is a negative aspect of their form if negotiated as with the system in FIG. 4.

Thus there may be incidental angles that a coach may not think of as poor form until it is pointed out to them through the classification process, for example a hip shoulder ankle angle that changes at the same time as glutes are moving backwards; the system can answer a question the coach may never has posed: How far does the hip should ankle angle and glutes angle have to be in conjunction with one another for a position to be considered poor? A coach may not have considered or would not have calculated what threshold values are for such an angle, or even that the angle is significant, but with labeled data and training models based on classified video/pose data, the decision boundary to use the angle and what its threshold values are may be discovered. The machine learning and form feedback models (726) also provide a further improvement of automatically providing a translation of ideas such as “never knees over toes” or “hip shoulder ankle angle in conjunction of 64 degrees threshold with glutes” into a numerical and/or quantitative description.

Synchronization and Time Scales. There are different time scales at which the above calculations may occur. In one embodiment, the trainer (702) and/or system finds the ends of repetitions, with a subsystem finding when a repetition is considered complete. For example, for one type of form feedback, data is pooled until the end of the rep and/or near the end of the rep. The data over the rep is calculated as a batch to answer what the minimum actuator/cable position was during the rep, in order to provide form feedback and/or ROM analysis. Thus, the timescale does not necessarily be only continuously streaming throughout.

Time Alignment and Reference Time Axis. In one embodiment, collected cable data/motor data (722) is used as a reference for a time axis, or any other data that has low latency/low desynchronization, such as cable/motor data (722) which is wired rather than wireless through WiFi/Bluetooth/4G/5G. In one embodiment, the time axis data like cable/motor data (722) may be used as a main clock. Based on the time axis data, synchronization is applied to other data such as camera data (742), IMU data (722), and/or pose data (746). In one embodiment, synchronization includes a rolling window and/or time-to-live signals to ensure relevance to data. In one embodiment, camera data (742) and/or pose data (746) is timestamped in reference to cable/motor data (722). In one embodiment, movement phase such as concentric phase, eccentric phase, and/or isometric phase are tracked and also used to provide a rolling window and/or time-to-live timeout to discard irrelevant or spurious data.

Classifiers. One example of a classifier is that for a single leg Romanian deadlift movement. The single leg Romanian deadlift movement is a technical movement with many limb/joint motion. In one embodiment, the classifier is written in software code such as Python, and as output provides a guidance score. In one embodiment, the classifier is machine generated based at least in part on training videos. In one embodiment, the classifier is adjusted and/or hand edited based at least in part on aggregated results.

Inverse Kinematic Tutorial. In one embodiment, guidance models (726) may be compared to a user video (742), user pose data (746), and/or motor/cable data (722), and guidance may include an inverse kinematic tutorial, referred to herein as guidance using inverse kinematics. For example, if a knee is determined to be in a poor form within guidance data (728), for example using trigger rules and/or using trigger rules run backwards into degenerative models, inverse kinematics may be used to take the user pose data (746) and revised with the knee in good form, then using motion retargeting with the revised pose data (746) to demonstrate to the user what they would look like with improved form.

IMU Data and Actuator/Joint Rotation. In one embodiment, IMU data (722) may be used to provide enhanced guidance. For example, for bicep curls and/or bench press with dumbbells, the position of the handle/actuator/hand may be parallel or at a 90-degree rotation for different training purposes and/or different muscle groups exercised. As an improvement to reduce computational resources, the rotation may be parameterized using IMU data (722) and/or computer vision of the hand joint. A result of sensor fusion with the IMU is that instead of form feedback variables such as “good_bench_press” or “poor_bench_press_form”, the system may be more specific with “poor_rotation_of_wrist_during_bench_press”.

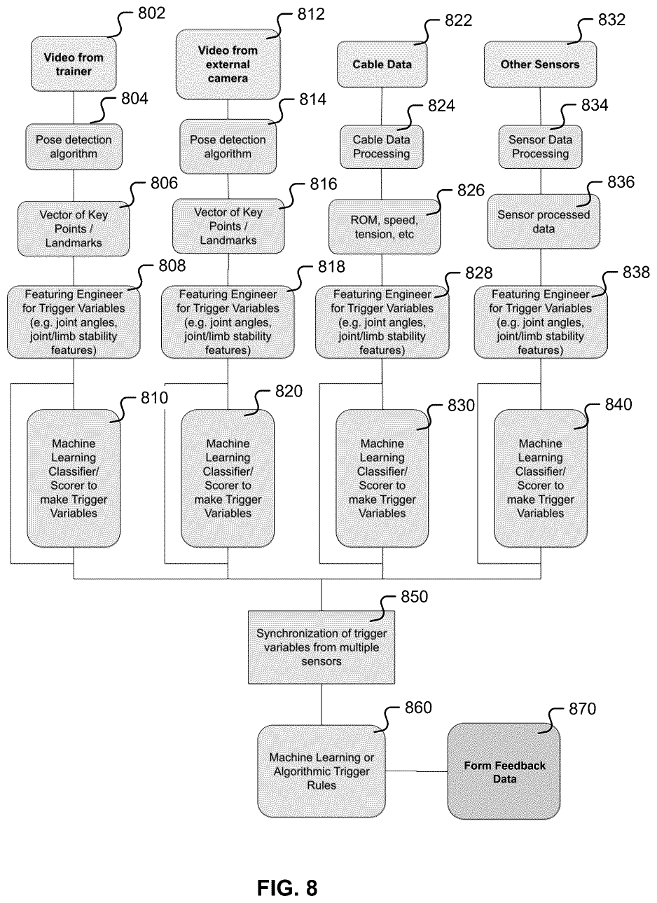

FIG. 8 is a block diagram illustrating an embodiment of a data pipeline for synthesis of form feedback data. In one embodiment, the data pipeline shown in FIG. 8 is processed by the system of FIG. 7.

As shown in FIG. 8, data may come from a plurality of sensor sources including: video (802) from the trainer (702) shown in FIG. 7; video (812) from an external/mobile device (704) shown in FIG. 7; cable and/or motor data (822); and/or other sensors such as IMU data and/or lidar data (832). In one embodiment, these sensor sources are indicated on FIG. 2 as the sensor (210) or a remote sensor not shown in FIG. 2.

For video (802) and video (812), corresponding pose detection algorithms (804) and (814) may be used, respectively, for example pose data models (744) shown in FIG. 7. Data preprocessing and/or processing may be similarly applied to cable data processing (824) and/or other sensor processing (834).

The output of the video/pose detection processing (804), (814) is a vector of key points/landmarks/joints (806), (816) respectively, such as a 32-point vector at the time of each frame of video. The output of the cable data processing (824) is a series of data such as range of motion, speed, tension, acceleration, and so on (826). The output of other sensor processing (834) includes sensor processed data (836).

Feature engineering may be used to transform data into a form easier to interpret. In one embodiment, a featuring engineer for trigger variables (808), (818), (828), (838) for each of the respective processed data (806), (816), (826), (836) creates features, starting from its respective lower-level data. For example, for the video processing case (808), (818), the lower-level data is the pose data/vector output (806), (816) such as 32 element vector pose landmarks. Aggregated features may be created such as angles, lengths, and/or stability metrics. Examples of features are “right elbow angle,” “left shoulder mean deviation,” or “left knee over toe.”

Classifiers and/or scorers (810), (820), (830), (840) may be used for each of the respective featuring engineers (808), (818), (828), (838), in order to create and/or establish trigger variables such as “InlineChestPressHipTorsoFlexionProbability” and “RepCountSinceSetResumed”. These trigger variables are all synchronized (850), and trigger rules (860) are used to provide a guidance such as a form feedback variables (870) for input to the system of FIG. 4.

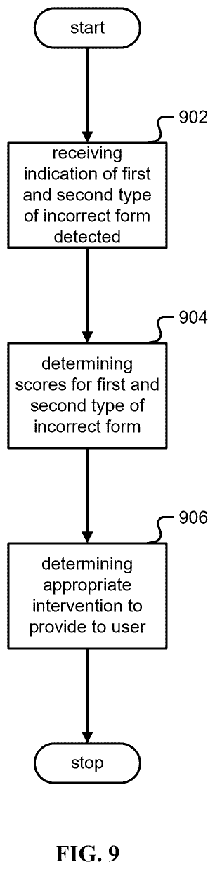

FIG. 9 is a flow diagram illustrating an embodiment of a process for form feedback negotiation. In one embodiment, the flow of FIG. 9 is carried out by the processor (208) of FIG. 2.

In step (902), an indication is received of a first and a second type of incorrect form detected. In one embodiment, an indication is received that, for a repetition of an exercise movement performed by a user: a first type of incorrect form has been detected with performing of the repetition of the exercise movement; and a second type of incorrect form has been detected with performing of the repetition of the exercise movement. In one embodiment, the first type and second type of incorrect form are detected based on sensor data collected from one or more hardware sensors, such as hardware sensor (210) in FIG. 2 and/or a remote hardware sensor not shown in FIG. 2. In one embodiment, the hardware sensor is at least one of the following: a camera, a cable-based sensor, an actuator-based sensor, an inertial unit in an actuator, or a smartwatch sensor.

In one embodiment, the processor (208) is coupled to the hardware sensor (210) via at least one of the following: a network connection, a bus connection, an internet connection, a Bluetooth connection, a WiFi connection, a cellular connection, a serial connection, a parallel connection, or a USB connection.

In step (904), scores are determined for the first and the second type of incorrect form. In one embodiment, respective first and second scores for the first and second types of incorrect form that have been detected are determined. In one embodiment, determining respective first and second scores comprises at least one of the following: scoring based at least in part on magnitude, scoring based at least in part on frequency, scoring adjusted by external contextual information, weighted scoring, dynamically adjustable weighted scoring in part to lower priority of the second type of incorrect form to the first type of incorrect form.

In a step not shown in FIG. 9, the first type of incorrect form and the second type of incorrect form are prioritized according to the respective first and second scores.

In one embodiment, determining respective first and second scores is based at least in part on a knowledge graph. In one embodiment, the knowledge graph comprises a retrieval augmented generation (RAG) large language model (LLM). In one embodiment, the knowledge graph constrains an LLM using a plurality of complex relationships instead of using a database of natural language files to refine the LLM output.

In step (906), an appropriate intervention to provide to the user is determined based at least in part on the scoring. In one embodiment, the appropriate intervention is provided to the user via the output controller (204) in FIG. 2. In one embodiment, an output device (206) and/or remote output device (232) coupled to the output controller (204) is at least one of the following: a cable-based haptic device, an actuator-based haptic device, a smartwatch-based haptic device, a display, a speaker, a smartwatch-based speaker, or a device for outputting one or more of the following: a text prompt, an audio prompt, a visual overlay, or a haptic feedback.

In one embodiment, the processor (208) is coupled to the output device (206) and/or remote output device (232) via at least one of the following: a network connection, a bus connection, an internet connection, a Bluetooth connection, a WiFi connection, a cellular connection, a serial connection, a parallel connection, or a USB connection.

In one embodiment, the appropriate intervention is provided to the user via the output controller prior to a subsequent repetition. In one embodiment, the appropriate intervention is determined to be a no output intervention. In one embodiment, the appropriate intervention is determined to be an intervention addressing the first incorrect form but not the second incorrect form.

In one embodiment, determining the appropriate intervention comprises determining that a feedback prompt to the user to adjust their form in performing of the exercise movement should be provided with respect to the first type of detected incorrect form and not the second type of detected incorrect form based on prioritizing.

In one embodiment, appropriate intervention is provided upon completion of a set in which the first repetition is comprised. In one embodiment, appropriate intervention comprises a summarization of form feedback including prompts with respect to both the first type and the second type of detected incorrect form.

In a step not shown in FIG. 9, on a subsequent repetition of the exercise movement, it is determined that the first type of incorrect form of the first repetition was not detected in the subsequent repetition. In one embodiment, determining that the first type of incorrect form of the first repetition was not detected in the subsequent repetition is based at least in part on a count of occurrence of the first type of incorrect form not increasing. In a step not shown in FIG. 9, a prompt is provided to the user via the output controller indicating that the incorrect form has been corrected.

Although the foregoing embodiments have been described in some detail for purposes of clarity of understanding, the invention is not limited to the details provided. There are many alternative ways of implementing the invention. The disclosed embodiments are illustrative and not restrictive.

1. A system for providing form feedback, comprising:
a hardware sensor;
an output controller configured to provide a message to a user performing an exercise movement;
a processor coupled to the hardware sensor and the output controller, wherein the processor is configured to:
receive an indication that, for a first repetition of the exercise movement performed by the user:
a first type of incorrect form has been detected with performing of the first repetition of the exercise movement;
a second type of incorrect form has been detected with performing of the first repetition of the exercise movement; and
wherein the first type of incorrect form and second type of incorrect form are detected based on sensor data collected at least in part from the hardware sensor;
determine respective first and second scores for the first and second types of incorrect form that have been detected, based at least in part on a first practical severity of the first type of incorrect form and a second practical severity of the second type of incorrect form, wherein the first practical severity is less severe than the second practical severity; and
determine an appropriate intervention to provide to the user via the output controller while the user is performing the exercise movement and before the end of a first set of the exercise movement, based at least in part on the scoring;
wherein the appropriate intervention suppresses a second feedback for the second type of incorrect form and outputs a first feedback for the first type of incorrect form, based at least in part on a determination that the first score exceeds a first threshold before the second score exceeds a second threshold.

2. The system of claim 1, wherein the hardware sensor is at least one of the following: a camera, a cable-based sensor, an actuator-based sensor, an inertial unit in an actuator, or a smartwatch sensor.

3. The system of claim 1, wherein an output device coupled to the output controller is at least one of the following: a cable-based haptic device, an actuator-based haptic device, a smartwatch-based haptic device, a display, a speaker, a smartwatch-based speaker, or a device for outputting one or more of the following: a text prompt, an audio prompt, a visual overlay, or a haptic feedback.

4. The system of claim 1, wherein the processor is coupled to the hardware sensor via at least one of the following: a network connection, a bus connection, an internet connection, a Bluetooth connection, a WiFi connection, a cellular connection, a serial connection, a parallel connection, or a USB connection; and wherein the processor is coupled to an output device via at least one of the following: a network connection, a bus connection, an internet connection, a Bluetooth connection, a WiFi connection, a cellular connection, a serial connection, a parallel connection, or a USB connection.

5. The system of claim 1, wherein determining respective first and second scores comprises at least one of the following: scoring based at least in part on magnitude, scoring based at least in part on frequency, scoring adjusted by external contextual information, weighted scoring, or dynamically adjustable weighted scoring in part to lower priority of the second type of incorrect form to the first type of incorrect form.

6. The system of claim 1, wherein the appropriate intervention is provided to the user via the output controller prior to a subsequent repetition.

7. The system of claim 1, wherein the appropriate intervention is determined to be of no output.

8. The system of claim 1, wherein the appropriate intervention is determined to be an intervention addressing the first incorrect form but not the second incorrect form.

9. The system of claim 1, wherein the processor is further configured to prioritize the first type of incorrect form and the second type of incorrect form according to the respective first and second scores.

10. The system of claim 8, wherein determining the appropriate intervention comprises determining that a feedback prompt to the user to adjust their form in performing of the exercise movement should be provided with respect to the first type of detected incorrect form and not the second type of detected incorrect form based on the prioritizing.

11. The system of claim 1, wherein the appropriate intervention is provided upon completion of a set in which the first repetition is comprised.

12. The system of claim 10, wherein the appropriate intervention comprises a summarization of form feedback including prompts with respect to both the first type and the second type of detected incorrect form.

13. The system of claim 1, wherein the processor is further configured to, on a subsequent repetition of the exercise movement, determine that the first type of incorrect form of the first repetition was not detected in the subsequent repetition.

14. The system of claim 12, wherein determining that the first type of incorrect form of the first repetition was not detected in the subsequent repetition is based at least in part on a count of occurrence of the first type of incorrect form not increasing.

15. The system of claim 12, wherein the processor is further configured to provide a prompt to the user via the output controller indicating that the incorrect form has been corrected.

16. The system of claim 1, wherein determining respective first and second scores is based at least in part on a knowledge graph.

17. The system of claim 15, wherein the knowledge graph comprises a retrieval augmented generation (RAG) large language model (LLM).

18. The system of claim 15, wherein the knowledge graph constrains an LLM using a plurality of complex relationships instead of using a database of natural language files to refine the LLM output.

19. A method for providing form feedback, comprising:
receiving an indication that, for a repetition of an exercise movement performed by a user:
a first type of incorrect form has been detected with performing of the repetition of the exercise movement; and
a second type of incorrect form has been detected with performing of the repetition of the exercise movement;
wherein the first type and second type of incorrect form are detected based on sensor data collected from one or more hardware sensors;
determining respective first and second scores for the first and second types of incorrect form that have been detected, based at least in part on a first practical severity of the first type of incorrect form and a second practical severity of the second type of incorrect form, wherein the first practical severity is less severe than the second practical severity; and
determining an appropriate intervention to provide to the user via an output controller before the end of a first set of the exercise movement, based at least in part on the scoring;
wherein the output controller is configured to provide a message to a user performing the exercise movement while the user is performing the exercise movement, and
wherein the appropriate intervention suppresses a second feedback for the second type of incorrect form and outputs a first feedback for the first type of incorrect form, based at least in part on a determination that the first score exceeds a first threshold before the second score exceeds a second threshold.

20. A computer program product for providing form feedback embodied in a non-transitory computer readable medium and comprising computer instructions for:
receiving an indication that, for a repetition of an exercise movement performed by a user:
a first type of incorrect form has been detected with performing of the repetition of the exercise movement; and
a second type of incorrect form has been detected with performing of the repetition of the exercise movement;
wherein the first type and second type of incorrect form are detected based on sensor data collected from one or more hardware sensors;
determining respective first and second scores for the first and second types of incorrect form that have been detected, based at least in part on a first practical severity of the first type of incorrect form and a second practical severity of the second type of incorrect form, wherein the first practical severity is less severe than the second practical severity; and
determining an appropriate intervention to provide to the user via an output controller before the end of a first set of the exercise movement, based at least in part on the scoring;
wherein the output controller is configured to provide a message to a user performing the exercise movement while the user is performing the exercise movement, and
wherein the appropriate intervention suppresses a second feedback for the second type of incorrect form and outputs a first feedback for the first type of incorrect form, based at least in part on a determination that the first score exceeds a first threshold before the second score exceeds a second threshold.
